(19) United States
(12) Patent Application Publication
(10) Pub. No.: US 2026/0172274 A1
(43) Pub. Date: Jun. 18, 2026

(54) VIDEO DISPLAY DEVICE, VIDEO DISPLAY SYSTEM, AND METHOD FOR CONTROLLING VIDEO DISPLAY DEVICE

(71) Applicant: MAXELL, LTD., Kyoto (JP)

(72) Inventors: Nobukazu KONDO, Kyoto (JP); Yasunobu HASHIMOTO, Kyoto (JP); Kazuhiko YOSHIZAWA, Kyoto (JP); Hitoshi AKIYAMA, Kyoto (JP); Junji SHIOKAWA, Kyoto (JP)

(21) Appl. No.: 19/126,269

(22) PCT Filed: Nov. 7, 2022
(86) PCT No.: PCT/JP2022/041324

§ 371 Date: May 1, 2025

(51) Int. Cl. H04L 12/18; G06F 3/01; G06T 19/00; H04L 65/403

(52) U.S. Cl. CPC H04L 12/1818; G06F 3/013; G06T 19/006; H04L 12/1831; H04L 65/403; G06T 2219/024

(57) ABSTRACT

A video display device includes a participation detection sensor configured to detect whether a user is participating in a conversation in a virtual and a communication transceiver configured to receive video information about the virtual space in which a self-avatar is present, video information about another-avatar corresponding to another user, and audio information about the other user, generates a video in which the other-avatar is arranged in the virtual space, determines whether the user is in a temporarily absent state in which the user is not participating in the conversation with the self-avatar being arranged in the virtual space, and upon determining that the other avatar is speaking to the self-avatar while the user is in the temporarily absent state, notifies the user.

### TECHNICAL FIELD

The present invention relates to a video display device, a video display system, and a video display device control method.

### BACKGROUND ART

In recent years, a variety of products have appeared on the market for information terminals such as PCs. One of the examples of them is a head mounted display (hereafter, referred to as “HMD”) as a mobile video display device. As HMDs, AR (Augmented Reality) glasses designed to superimpose and display a three-dimensional image of augmented reality and an immersive HMD provided with a display screen that completely covers the eyes, on which a three-dimensional image of virtual reality (VR) is to be displayed, have been known.

As application software available for HMDs, a remote conferencing system is used. Using the remote conferencing system allows all the participants to enter the same virtual conference room through a network and have a remote conference among them although they are present in different places. In the remote conference, each participant watches the images of the virtual conference room in which an image that represents himself or herself (avatar) and images that represent the other participants (avatar) are arranged, using his or her own HMD.

With regard to a technique for displaying avatars, Patent Literature 1 states “a display control device acquires information from a device used by a user for having an online conference. The display control device determines a situation of the user based on the acquired information. The display control device controls a display mode of an avatar corresponding to the user, which is shown to other users participating in the online conference, depending on the situation as determined (excerpted from Abstract)”.

### CITATION LIST

### Patent Literature

### Patent Literature 1: JP-A-2022-95256

### SUMMARY OF INVENTION

### Technical Problem

According to the technique described in Patent Literature 1, controlling the display mode of an avatar enables whether a user who is a member of the online conference is seated or whether he or she is engaged in other work to be known. However, if a user who is absent is spoken by other members, he or she would not be aware of it. Thus, temporary absence of a user who is a member of an online conference may cause delay of a conversation in the online conference.

An object of the present invention is to provide a video display device, a video display system, and a video display device control method, which can prevent an online conference from being disturbed by temporary absence of a user.

### Solution to Problem

In order to solve the object described above, the present invention is provided with the features described in the scope of claims. One of the aspects thereof is a video display device, comprising: a processor; a display; a participation detection sensor configured to detect whether a user is participating in a conversation in a virtual space received via the video display device; and a first communication transceiver configured to receive video information about the virtual space in which a self-avatar corresponding to the user is present, video information about another avatar corresponding to another user, and audio information about the other user from an external device, the processor being configured to: based on the video information about the virtual space and the video information about the other avatar, generate a video in which the other avatar is arranged in the virtual space to display the video as generated on the display; determine whether the user is in a temporarily absent state in which the user is not participating in the conversation with the self-avatar being arranged in the virtual space, based on a sensor output from the participation detection sensor; and upon determining that the other avatar is speaking to the self-avatar based on the audio information while the user is in the temporarily absent state, carry out control for providing the user with a notification.

### Advantageous Effects of Invention

According to the present invention, it is possible to provide a video display device, a video display system, and a video display device control method, which can prevent an online conference from being disturbed by temporary absence of a user. The problems, configurations, and advantageous effects other than those described above will be clarified by explanation of the embodiments below.

### BRIEF DESCRIPTION OF DRAWINGS

FIG. 1 schematically illustrates a configuration of a video display system according to the present embodiment.

FIG. 2A is a configuration diagram of an example of AR (see-through) glasses.

FIG. 2B is a configuration diagram of an example of an immersive (non-see-through) HMD.

FIG. 3 is a hardware configuration diagram of an HMD.

FIG. 4 illustrates a flowchart of a process to be carried out by a processor of an HMD.

FIG. 5 schematically illustrates a virtual conference room as viewed from above.

FIG. 6A schematically illustrates a virtual conference room as viewed from above.

FIG. 6B schematically illustrates a display image of a virtual conference room on an HMD.

FIG. 7 illustrates a flowchart of a process procedure in a temporary absence process in step S409 to be executed by a processor.

FIG. 8A schematically illustrates a virtual conference room as viewed from above.

FIG. 8B schematically illustrates a display image of a virtual conference room on an HMD.

FIG. 9 schematically illustrates a display image on a mobile information terminal.

FIG. 10 schematically illustrates an operation of a mobile information terminal upon receiving a notification instruction.

FIG. 11 schematically illustrates an operation in a remote control mode.

FIG. 12A schematically illustrates a virtual conference room as viewed from above.

FIG. 12B schematically illustrates a display image of a virtual conference room on an HMD.

FIG. 13 schematically illustrates a state in which an HMD is performing an audio notification operation.

FIG. 14 schematically illustrates a display image of a virtual conference room on an HMD.

FIG. 15 schematically illustrates a display image of a virtual conference room on an HMD.

FIG. 16 is a functional block diagram of a video display program to be executed by a processor.

FIG. 17 illustrates a flowchart of a flow of a process for detecting a conversation to a self-avatar.

### DESCRIPTION OF EMBODIMENTS

Hereinafter, embodiments of the present invention will be described with reference to the drawings. In each of the drawings for explaining the embodiments, the same member is generally provided with the same reference sign, and repetitive explanation therefor will be omitted.

According to the present invention, improvement in work efficiency in the case where a user attends an online conference using metaverse while working on a task in a real environment at the same time can be expected. Thus, the present invention is expected to improve a technology for labor-intensive industries involving work support and back-office support, and therefore, can contribute to the Sustainable Development Goals (SDGs), specifically Goal 8.2 (Achieve higher levels of economic productivity through diversification, technological upgrading and innovation, including through a focus on high-value added and labor-intensive sectors” proposed by the United Nations.

### First Embodiment

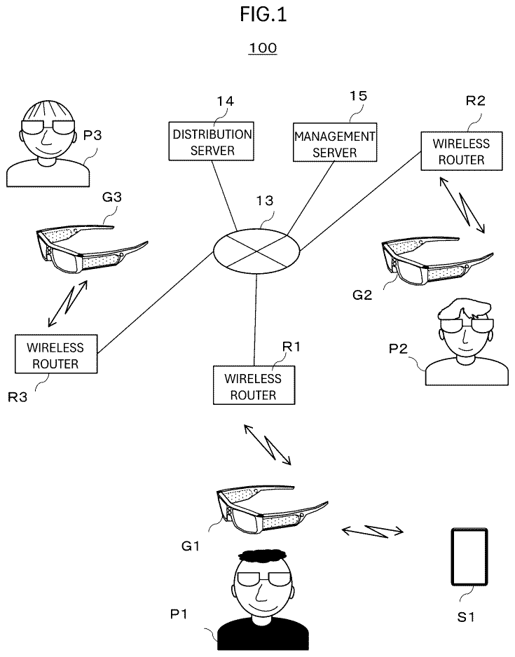

FIG. 1 schematically illustrates a configuration of a video display system according to the present embodiment. The present invention is applied to a case with a plurality of users, and in the present embodiment, as illustrated in FIG. 1, a particular case with three users (first user P1, second user P2, and third user P3) will be described for the purpose of clarifying the explanation. In the following, the present embodiment will be described with reference to an example using a head-mounted display (HMD) as a video display device.

In a video display system 100 illustrated in FIG. 1, an HMD G1 worn by the first user P1 is connected to a communication network 13 via a wireless router R1. An HMD G2 worn by the second user P2 is connected to the communication network 13 via a wireless router R2. An HMD G3 worn by the third user P3 is connected to the communication network 13 via a wireless router R3. Furthermore, a distribution server 14 and a management server 15 are connected to the communication network 13, respectively. Each of the distribution server 14 and the management server 15 is an example of an external device.

The distribution server 14 distributes, to the HMD G1, the HMD G2, the HMD G3, various types of video information such as information about a virtual conference room registered in advance in the video display system 100, information about an object corresponding to an object in the virtual conference room which will be described later, an information about an avatar image of a user, and live content data. On each of the HMD G1, the HMD G2, and the HMD G3, a video is displayed on its display and the audio is output from its speaker.

The management server 15 manages a plurality of pieces of information acquired via the communication network 13. The information to be managed by the management server 15 includes, for example, information about a user which will be described later. The information about a user includes operation information about the HMD G1 (operation information about the first user P1), audio information about the first user P1, operation information about the HMD G2 (operation information about the second user P2), audio information about the second user P2, operation information about the HMD G3 (operation information about the third user P3), and audio information about the third user P3. The operation information about each user is indicated as vector information based on a sensor output which is detected by a sensor mounted on the HMD worn by the user in response to the motion made by the user, such as shaking the head, standing, sitting, and moving. The avatar corresponding to each user is displayed with the motion corresponding to the vector information for the motion made by each user.

Furthermore, the information about a user includes user identification information including a name, a nickname, a screen name, and the like, video information about an avatar, management information for managing a plurality of users who are participating in and view a conference in a virtual conference room at the same time, and the like.

With this system configuration, each user can participate in the conference in the virtual conference room while viewing an image in which an avatar of another user, who is a person different from himself or herself, is superimposed on an image of the virtual conference room.

In FIG. 1, pairing between the HMD G1 and a smartphone as a mobile information terminal S1 is established by near-field wireless communication or LAN communication. This enables transmission and reception of audio data, text message data, and image data between the HMD G1 and the smartphone. The mobile information terminal is not limited to a smartphone, and may be any electronic device as long as it allows pairing with an HMD, for example, a wearable terminal, a tablet, and a smart speaker. Here, the wearable terminal includes a smartwatch, wireless earphones, and a wireless headphone.

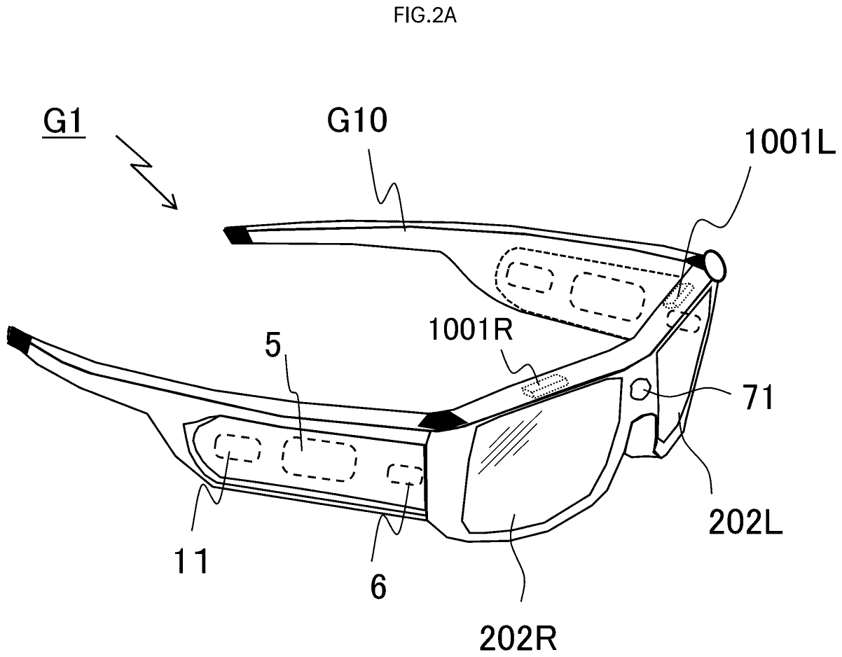

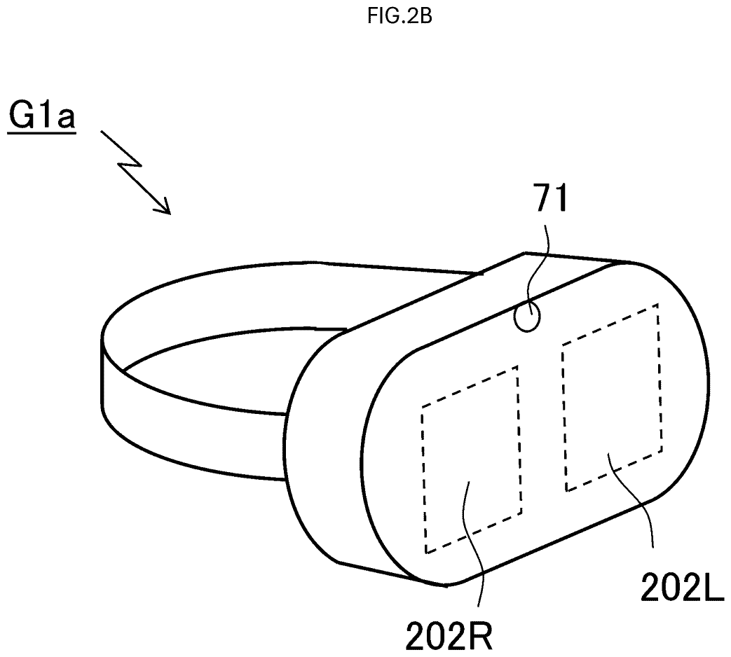

FIG. 2A illustrates an example of a configuration of AR (see-through) glasses.

The HMD G1 illustrated in FIG. 2A includes a housing G10 in the form of eyeglasses, which is provided with a left display 202L and a right display 202R both having display surfaces. The left display 202L and the right display 202R are, for example, see-through displays, respectively. A real image of the external field passes through the display surfaces of the left display 202L and the right display 202R, respectively, and an image generated by a computer is superimposed and displayed on the real image. The housing G10 includes a control device 11, a camera 71, a communication transceiver 6, sensors 5 including various sensors, and the like. The control device 11 includes the processor 2, the bus 3, and the memory 4, which will be described later. Furthermore, the control device 11 may include an audio recognition processor 82, a decoder 83, and an encoder 84. Each of the HMD G2 and the HMD G3 is configured in the same manner as the HMD G1, and thus will not be described herein.

FIG. 2B illustrates an example of a configuration of an immersive (non-see-through) HMD.

An immersive HMD G1a illustrated in FIG. 2B significantly differs from the HMD G1 in the form of eyeglasses in that the right display 202R and the left display 202L are not see-through displays. The HMD G1a is generally provided with a through mode as one of the control modes. The user wearing the HMD G1a cannot directly see the scenes of the external field. If the user tries to see the scene in the external field while wearing the HMD G1a, he or she needs to switch its mode to the through mode for displaying, for example, an image captured by the camera 71, on the right display 202R and the left display 202L.

In the see-through HMD G1, the through mode may be the mode allowing a real image of the external environment to be easily viewed, for example, by not to superimposing and displaying an image generated by a computer, or even if superimposing and displaying an image generated by a computer, displaying it on the edge of the field of view.

The HMD G1a includes the processor, the communication transceiver, and the sensors 5 including various other sensors in the same manner as those illustrated in FIG. 2A although they are not illustrated in FIG. 2B.

The image display system 100 may employ a see-through HMD as illustrated in FIG. 2A, or may employ a non-see-through HMD as illustrated in FIG. 2B.

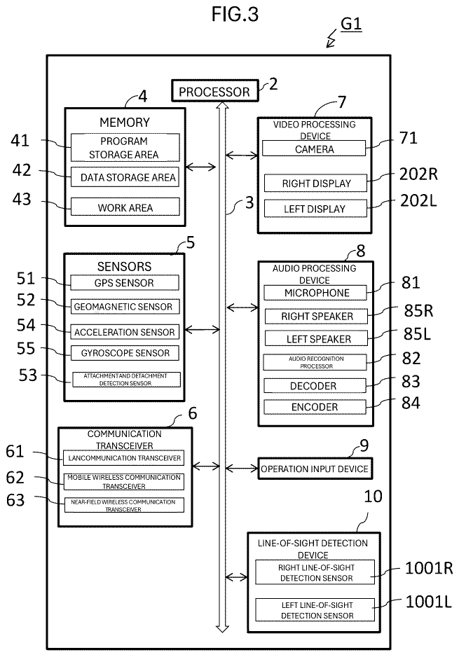

FIG. 3 is a hardware configuration diagram of an HMD according to the present embodiment. FIG. 3 exemplifies the HMD G1 while a non-see-through HMD is also configured in the same manner.

As illustrated in FIG. 3, the HMD G1 includes a processor 2, a bus 3, a memory 4, sensors 5, a communication transceiver 6, a video processing device 7, an audio processing device 8, an operation input device 9, and a line-of-sight detection device 10.

The processor 2 is a microprocessor unit for controlling overall operations of the HMD G1 in accordance with a predetermined operation program. The processor 2 mainly carries out the system control for processing on input performed by the user P1 of the HMD G1, transmitting and receiving information to and from the distribution server 14 and the management server 15 in response thereto, and processing the video display system 100 based on the information as transmitted and received, and also carries out generation and display control for images to be displayed.

The bus 3 is a data communication path for transmitting and receiving various commands, data, and the like among the processor 2 and the configuration blocks in the HMD G1, respectively.

The memory 4 includes a program storage area 41 for storing a program for controlling the operations of the HMD G1 and the like, a data storage area 42 for storing various kinds of data including an operation setting value, a detected value from the sensors 5 which will be described later, an image to be displayed, characters, and the like, and a rewritable work area 43 such as a work area to be used in various program operations.

The memory 4 includes a volatile memory and a non-volatile memory.

As a volatile memory, the memory 4 includes a RAM. The work area 43 is formed in the RAM.

The non-volatile memory includes, for example, a readable and writable non-volatile storage medium, such as a semiconductor memory, and a ROM. The semiconductor memory may be, for example, a flash memory or an SSD (Solid State Drive). In addition, a magnetic disk drive, such as an HDD (Hard Disc Drive), may be provided as a non-volatile storage medium. Providing a non-volatile memory enables stored information to be retained even when power is not being supplied to the HMD G1 from the outside.

The nonvolatile storage medium is capable of retaining an operating program downloaded from the communication network 13, various data generated by executing the operating program, contents such as a movie, a still image, and an audio as downloaded, and data such as a movie and a still image captured using the camera 71. Each operating program stored in the non-volatile storage medium can be updated and expanded by download processing with respect to a program server (not illustrated).

The sensors 5 is a generic term of various sensors for detecting the state of the HMD G1. The sensors 5 includes a GPS (Global Positioning System) sensor 51, a geomagnetic sensor 52, an acceleration sensor 54, a gyroscope sensor 55, and an attachment and detachment detection sensor 53.

Based on sensor outputs from the GPS sensor 51, the geomagnetic sensor 52, and the acceleration sensor 54, the position, tilting, direction, and motion of the HMD G1 can be measured.

Furthermore, based on the sensor output from the attachment and detachment detection sensor 53, whether the first user P1 is wearing or taking off the HMD G1 can be detected.

The attachment and detachment detection sensor 53 is not limited to a particular sensor, and may be any sensor as long as it is configured to detect that the HMD G1 is worn on the head of the first user P1. It may be, for example, a pressure sensor, a touch sensor, or a photo sensor, which is to be arranged on the inner side of the HMD.

The attachment and detachment detection sensor 53 is an example of a participation detection sensor configured to detect whether the first user P1 is participating in a conversation in the virtual space, which is received via the HMD G1.

The HMD G1 may further include other sensors such as an illuminance sensor, a proximity sensor, a biometric sensor, and the like.

The communication transceiver 6 includes a LAN (Local Area Network) communication transceiver 61, a mobile wireless communication transceiver 62, and a near-field wireless communication transceiver 63.

The LAN communication transceiver 61 is provided for connection to an external device through the communication network 13 such as the Internet via an access point, a wireless router, or the like. Thus, the LAN communication transceiver 61 corresponds to the first communication transceiver. The LAN communication transceiver 61 may be a wireless connection unit such as Wi-Fi (registered trademark). The HMD G1 can wirelessly connect to an access point, a wireless router, or the like via the LAN communication transceiver 61.

The mobile wireless communication transceiver 62 carries out telephone communication (call) and transmission and reception of data through the communication network 13 by wireless communication with a base station of a mobile wireless communication network (not illustrated). Communication with the base station or the like may be carried out by any other communication methods using, for example, W-CDMA (Wideband Code Division Multiple Access) (registered trademark), GSM (Global System for Mobile communications) (registered trademark), or LTE (Long Term Evolution), 4G, 5G or the like. The mobile wireless communication transceiver 62 is capable of communication with an external device as described above, and thus corresponds to the first communication transceiver.

Each of the LAN communication transceiver 61 and the mobile wireless communication transceiver 62 includes an encoding circuitry, a decoding circuitry, an antenna, and the like.

The near-field wireless communication transceiver 63 has a communication function of BlueTooth (registered trademark) system, however, it is not particularly limited thereto, and may employ any other communication system such as infrared-ray communication. The near-field wireless communication transceiver 63 is capable of wireless communication connection to a mobile information terminal to be notified, and thus it corresponds to a second communication transceiver.

The video processing device 7 includes a camera 71, a right display 202R, and a left display 202L. The camera 71 is a camera unit that converts visible light input from a lens into an electric signal using an electronic device such as a CCD (Charge Coupled Device) or a CMOS (Complementary Metal Oxide Semiconductor) sensor to input visible image data about surroundings and objects.

Furthermore, the camera 71 may include a TOF (Time Of Flight) sensor capable of acquiring a distance to an object being captured as a distance image. This enables, using the visible image and the distance image, accurate detection of, for example, the selection made by an operation of holding the hand over a plurality of displayed images being displayed on the HMD G1 and pinching one of them with the thumb and the index finger (hereinafter, referred to as a pointing operation). Furthermore, using the visible image and the distance image enables measurement of the distance to the object at which the user is gazing. Still further, by scanning the surroundings, a three-dimensional space map may be generated using the outputs from the sensors 5 and the image processing device 7 described above.

Each of the right display 202R and the left display 202L irradiates a display surface thereof with a projection light obtained from a display device such as a liquid crystal panel to display an image. Each of the right display 202R and the left display 202L includes a video RAM (not illustrated). Based on image data input in the video RAM, an image is displayed on the display screen.

The audio processing device 8 includes a microphone 81, the audio recognition processor 82, the decoder 83, the encoder 84, a right speaker 85R, and a left speaker 85L.

The microphone 81 converts the voice of a user or the like into audio data, and inputs the audio data as converted.

The right speaker 85R and the left speaker 85L output the audio information and the like necessary for the user.

The audio recognition processor 82 analyzes the audio information as received and extracts an instruction command or the like. The audio recognition processor 82 may be used to operate the HMD G1 with an audio command for providing an operation instruction, or may be used to analyze the voices of the users in the conference to analyze the conversation content.

The decoder 83 has a function of carrying out the decoding processing (audio synthesize processing) on the encoded audio signal or the like, and a three-dimensional audio processing function for each transmission property of the audio, and outputs three-dimensional audio to the user of the HMD G1 from the right speaker 85R and the left speaker 85L.

The encoder 84 carries out the encoding processing on the audio information as input to generate an encoded audio signal.

The operation input device 9 is a user interface for inputting an operation instruction to the HMD G1. The operation input device 9 may be, for example, an operation key including button switches or the like being arranged thereon, or may be configured as a device for inputting and analyzing a gesture motion. Furthermore, the operation input device 9 may be configured as a separate mobile terminal device connected to the HMD G1 by wired communication or wireless communication via the communication transceiver 6.

The line-of-sight detection device 10 detects a line-of-sight direction of the user who is wearing the HMD G1. For detecting the line of sight using a right line-of-sight detection sensor 1001R and a left line-of-sight detection sensor 1001L, a method of irradiating the eyes of the user with a non-visible light (infrared light or the like) to obtain a pupil image by the image processing performed on the captured image may be employed, however, not particularly limited thereto.

There is no particular limitation on the communication standard or system to be employed by the HMD G1, but via BlueTooth (registered trademark) which is a near-field wireless communication standard, the HMD G1 may be connected to, for example,
remote controllers to be held by the left and right hands of the user, respectively, which allow the user to press a button thereon to enter an operation instruction, or
a band with a built-in sensor capable of detecting motions of the hand and foot,
which are not illustrated herein.

From the sensor combined with the band, the motions of the hand, the arm, or the foot of the user P1 can be detected. Using the various functions of the sensors 5, user motion information including, for example, clapping the hands, shaking the head or the hand, raising or lowering the hand, standing, sitting, walking in place, stepping, and jumping can be detected.

Furthermore, by using the sensor output acquired from the geomagnetic sensor 52, the gyroscope sensor 55, or the like, it is possible to obtain angular information which is indicative of the horizontal direction of the HMD G1 worn by the user P1, and calculated based on the sensor output. Also, it is possible to obtain gaze direction information is calculated based on the sensor output from the line-of-sight detection device 10. The user motion information and the gaze direction information are collectively referred to as behavior information.

The hardware configuration of the mobile information terminal S1 illustrated in FIG. 1 is almost the same as the hardware configuration illustrated in FIG. 3, except that the mobile information terminal S1 does not have the line-of-sight detection device 10 or the like, but includes a single display which is not divided into the right display 202R and the left display 202L, and a touch panel laminated on the single display and allowing an input operation, and thus the detailed explanation therefor is omitted herein.

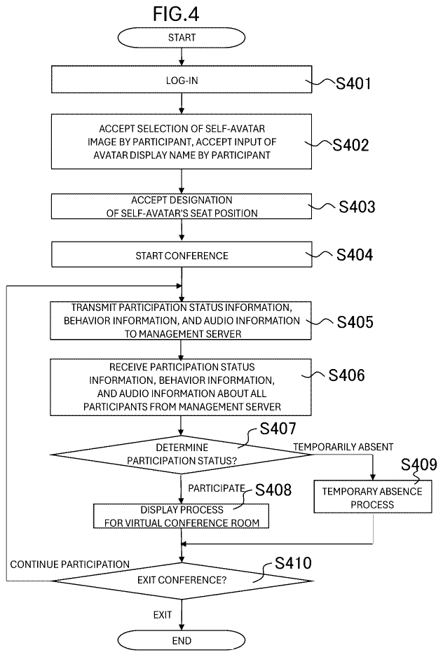

Next, conferencing by the first user P1, the second user P2, and the third user P3, who have entered a virtual conference room, using the video display system 100 will be described in detail with reference to FIG. 4 to FIG. 6.

FIG. 4 illustrates a flowchart of a process to be carried out by the processor 2 of the HMD G1 which is about to participate in a conference in a virtual conference room using the video display system 100. In the following, an example of a process for entry of the first user P1 (FIG. 1) into the virtual conference room will be explained in order. Here, it is assumed that information such as the number of members to attend the conference and the like has been registered in the video display system in advance.

Step S401: In a log-in process for logging in to the video display system 100 by the first user P1, the processor 2 of the HMD G1 transmits authentication information such as a user ID and a password to the management server 15. Upon approval of the log-in process by the management server 15 in step S401, the processor 2 proceeds to the next step.

Step S402: Upon selection of one of the avatar images being shown by the first user P1 as his or her own avatar, the processor 2 accepts the selection. Furthermore, the processor 2 accepts the input of the information such as the name or the nickname of the first user P1. How they should be input is not particularly limited, and the user may input characters being shown (such as on a software keyboard) by means of a pointing operation, or may perform audio input.

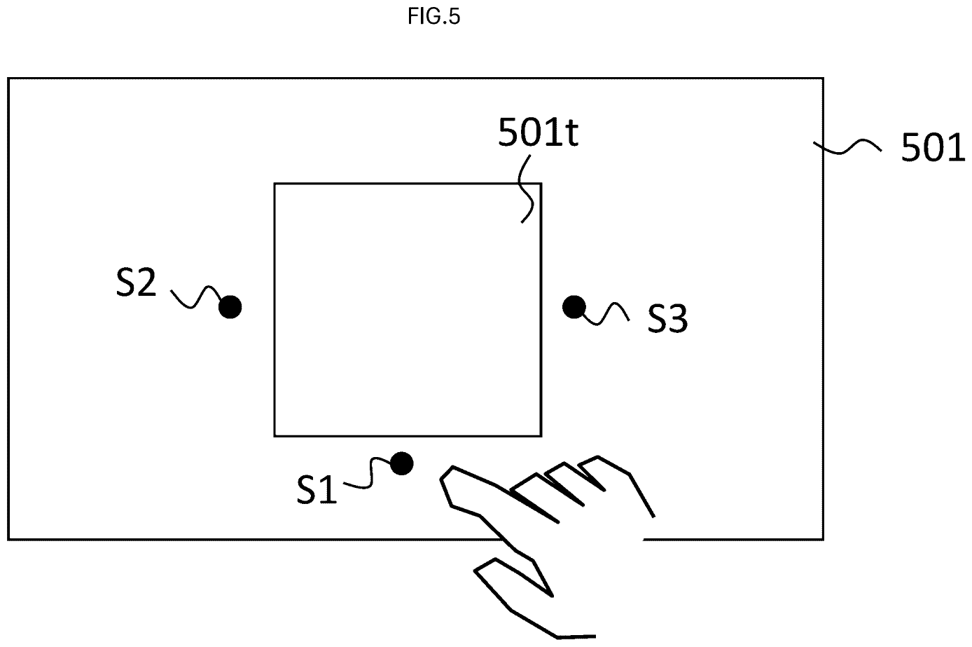

Step S403: As illustrated in FIG. 5, the processor 2 accepts a seat position of a self-avatar A1 of the first user P1, who is about to participate in the conference, within the virtual conference room, by means of a pointing operation or the like.

FIG. 5 schematically illustrates the virtual conference room as viewed from above.

The processor 2 shows a video of the virtual conference room 501 illustrated in FIG. 5 on the right display 202R and the left display 202L. A conference desk 501t is arranged in the virtual conference room 501. The seat positions S1, S2, S3 of the conference desk 501t are the positions where avatars, which can be selected in step S403, are to be seated, respectively. In the present embodiment, it is assumed that the first user P1 has selected the seat position S1 for the self-avatar A1 by performing a pointing operation in step S403.

Step S404: The processor 2 starts the conferencing process.

The second user P2 and the third user P3 perform the processes in steps S401 to S403 for the HMD G2 and the HMD G3 worn by themselves, respectively, whereby the processes for entry into the virtual conference room 501 by all the users are completed. In the present embodiment, it is assumed that, in step S403, the second user P2 and the third user P3 selected the seat position S2 and the seat position S3, respectively, when entering the virtual conference room 501.

Step S405: The processor 2 transmits participation status information and behavior information about the user P1, and also transmit audio information about the speech made by the user P1 which is obtained from the microphone 81 to the management server 15. The participation status information about the user P1 will be described in detail later.

The management server 15 broadcasts the participation status information and the behavior information received from the HMD G1 to the HMD G2 and the HMD G3 worn by all the other users who have entered the virtual conference room 501. The management server 15 performs the same process for the HMD G2 to the HMD G3 as that for the HMD G1.

Step S406: The processor 2 receives the participation status information, angular information, gaze direction information, and audio information about the other users, which have been broadcasted.

Step S407: The processor 2 makes determination on the participation status of the first user P1. If determining that the first user P1 is participating in the conference (S407: participating), the processor 2 executes a display process (S408) of displaying a video of the virtual conference room. If determining that the first user P1 is temporarily absent (S407: temporarily absent), the processor 2 executes a temporary absence process (S409). Details of the temporary absence process will be described later. The term “temporary absence” refers to a state in which the user is not participating in the conference in the virtual conference room while logging-in to the conference in the virtual space, that is, the user is not participating in the conference although the self-avatar of the user is being displayed in the virtual conference room on the HMDs of the other users.

For making determination on the participation status, the following criteria may be used.
(1) In the state where the output from the attachment and detachment sensor 53 of the HMD G1 is indicative of attachment, the HMD G1 is being used in the through mode.
(2) The output from the attachment and detachment sensor 53 of the HMD G1 is indicative of detachment.
(3) In the state where the output from the attachment and detachment sensor 53 of the HMD G1 is indicative of detachment, the HMD G1 is being used in a speaker output mode for outputting the conversation by the other avatars during the conference to the right speaker 85R and the left speaker 85L.

In the case (1) above, it is determined that the participation status information corresponds to a “temporary absence mode 1”. In the “temporary absence mode 1”, it is assumed that the user P1 is working on a task, which is different from participation in the conference, on a different personal computer using a keyboard and a mouse, but is ready to return to the conference in the virtual conference room 501 at any time depending on the situation of the conference.

In the case (2) above, it is determined that the participation status information corresponds to a “temporary absence mode 2”. In the “temporary absence mode 2”, it is assumed that the user P1 is working on a task, which is different from participation in the conference, on a different personal computer using a keyboard and a mouse, with the HMD G1 that has been detached being placed near him or her, or temporarily taken off the HMD G1 and moved to a placed away from the HMD G1 for doing other tasks.

In the case (3) above, it is assumed that the user P1 is working on a task, which is different from participation in the conference, on a different personal computer using a keyboard and a mouse, with the HMD G1 that has been taken off being placed near him or her while listening to the audio of the conference.

In the cases (1), (2), or (3) above, the temporary absence process in step S409 is to be executed. The details of the process to be executed in step S409 will be detailed later.

If none of the cases (1), (2), and (3) above is found, it is determined that the user P1 is participating in the remote conference. In this case, the processor 2 sets a “normal mode” in the participation status and executes the process in step S408.

How a switching process for turning on or off the through mode or the speaker mode is to be carried out is not particularly limited, and may be carried out by, for example, a button operation for the operation input device 9, or by a pointing operation for a menu being displayed on the right display 202R or the left display 202L.

Whether the HMD G1 has been taken off may be determined, instead of using the attachment and detachment detection sensor 53 as the participation detection sensor, based on the change in the amount of the sensor outputs from the geomagnetic sensor 52, the acceleration sensor 54, and the gyroscope sensor 55 over a certain period of time. In this case, the attachment and detachment detection sensor 53 does not have to be provided, which can advantageously reduce the mounted components and the cost.

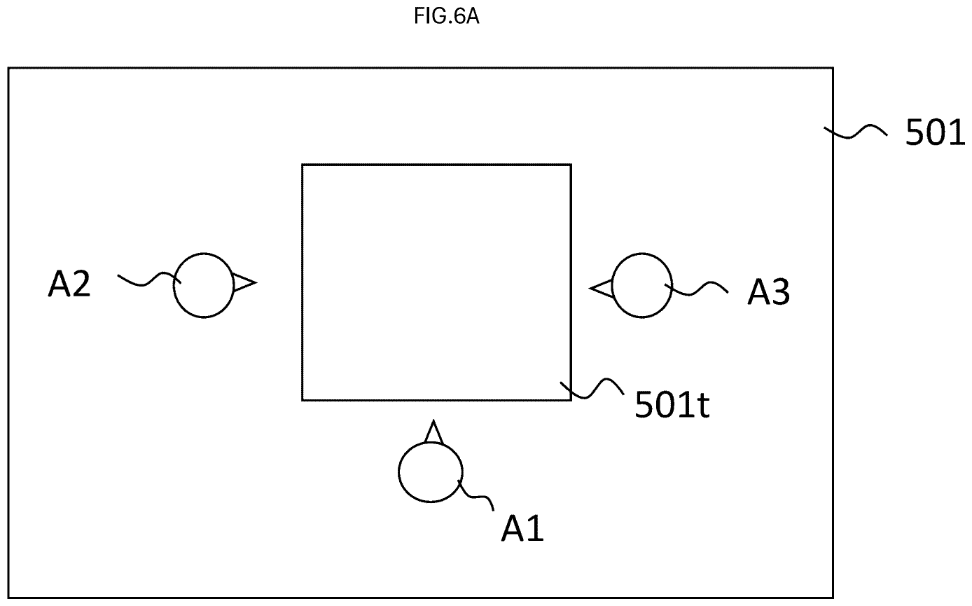

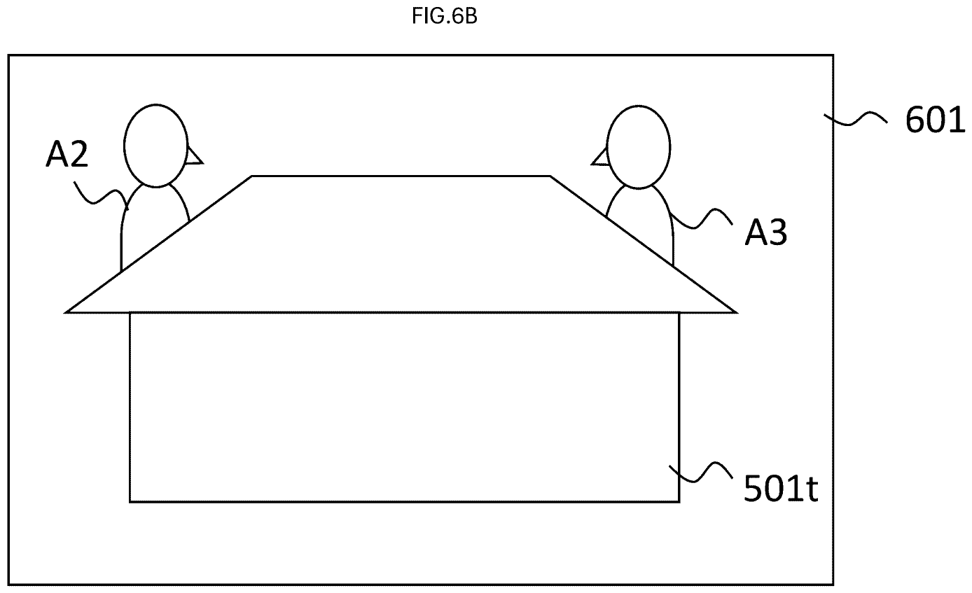

Step S408: Based on the participation status information and the gaze direction information about the other users received in step S406, as illustrated in FIG. 6B, the processor 2 carries out the display control for the images of the virtual conference room and output control for the audio information.

FIG. 6A schematically illustrates the virtual conference room 501 as viewed from above.

In FIG. 6A, the avatar A1 of the first user P1, the avatar A2 of the second user P2, and the avatar A3 of the third user P3 are seated facing the center of the conference desk 501t, respectively.

FIG. 6B schematically illustrates a display image of the virtual conference room 501 being displayed on the HMD G1 schematically illustrated in FIG. 6A.

A display image 601 illustrated in FIG. 6B is displayed on the right display 202R and the left display 202L mounted on the HMD G1. The display image 601 to be viewed by the first user P1 is the image of the scenery that the self-avatar A1 is seeing, and thus the avatar A1 is not included therein.

Step S410: If not finding an operation for exiting, for example, logging-out from the virtual conference room 501 by the user P1 (S410: continue participation), the processor 2 returns to step S405 and repeats the processes of step S405 to step S409. If finding the operation for exiting, for example, logging-out from the virtual conference room 501 by the user P1 (S410: exit), the processor 2 stops displaying the avatar A1 in the virtual conference room 501 and terminates the process.

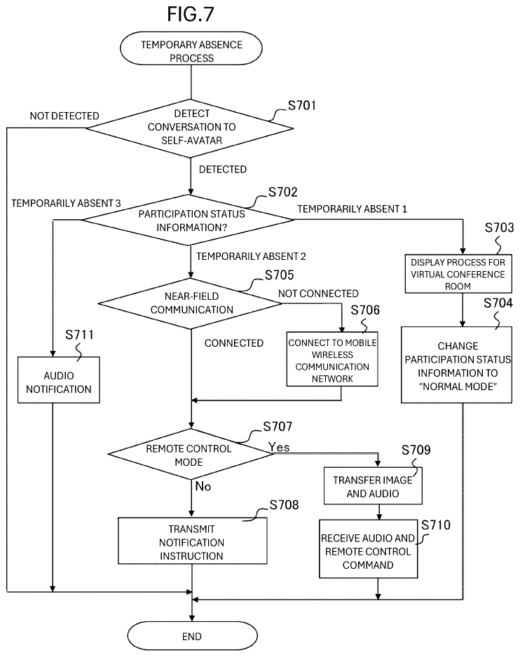

Next, the details of the temporary absence process in step S409 will be described with reference to FIG. 7 to FIG. 11. FIG. 7 illustrates a flowchart of a process procedure in the temporary absence process in step S409 to be executed by the processor 2.

Step S701: Upon determining that a conversation to the self-avatar A1 has been detected (S701: detected), the processor 2 executes the processes in step S702 and thereafter. On the other hand, if determining that a conversation to the self-avatar A1 has not been detected (S701: not detected), the processor 2 terminates the temporary absence process.

If detecting, as a detection condition of whether the self-avatar has been talked to, for example, one of the other users in the virtual conference room 501, that is, the avatar A2 of the second user P2 or the avatar A3 of the third user P3 is calling and speaking to the self-avatar A1, or looking at the direction of the avatar A1, the processor 2 executes the processes in step S702 and thereafter to provide the user P1 who has been absent with a notification. The detection condition further includes:
audio analysis (analysis of natural language or AI processing in the case where the name is not called);
behavior of other avatars (gesture, hand gesture, turning, line of sight, etc.);
gaze states of other avatars (use of majority processing); and
combination of the above.

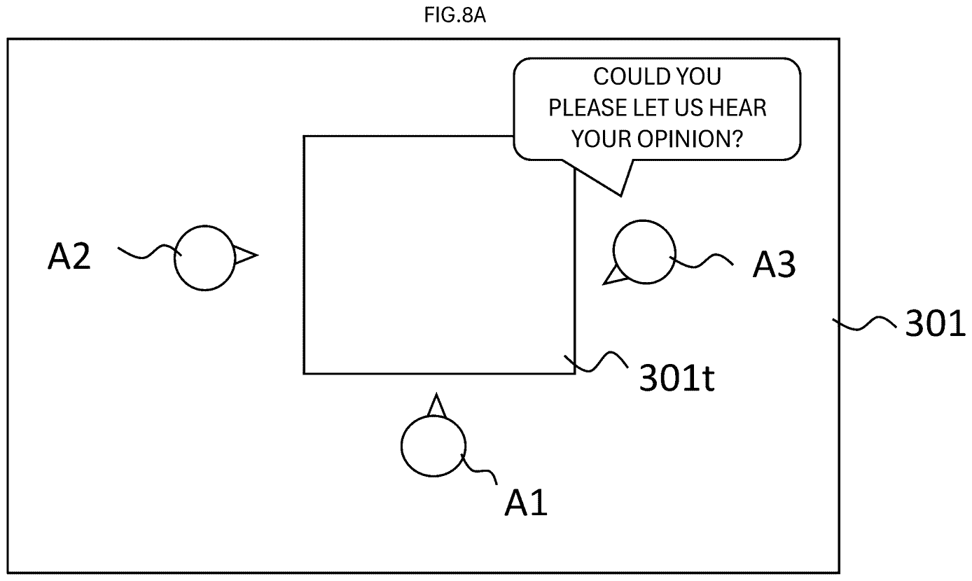

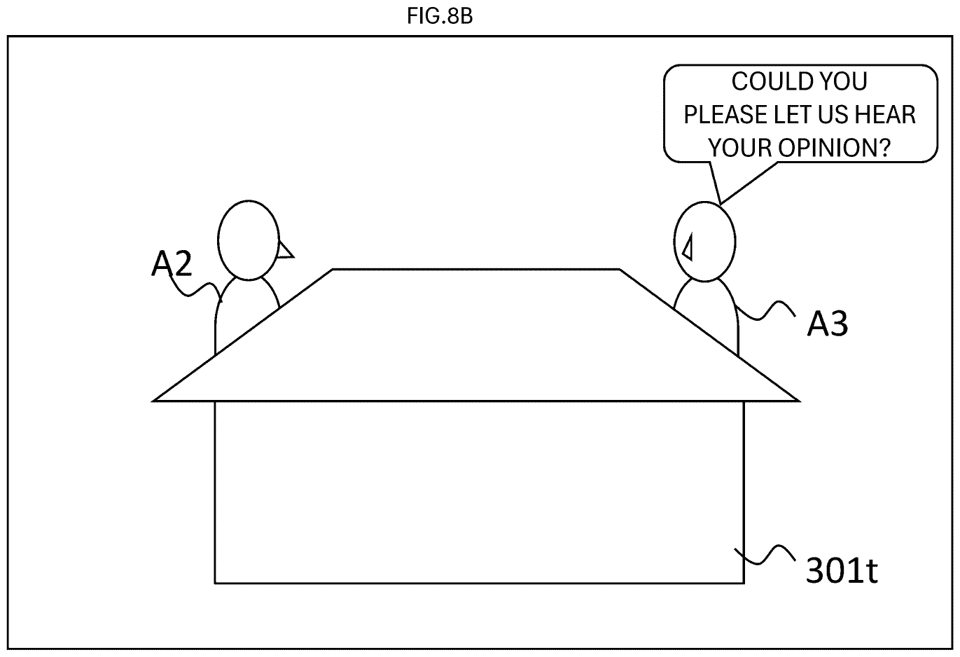

FIG. 8A schematically illustrates the virtual conference room 501 as viewed from above. FIG. 8B schematically illustrates a display image of the virtual conference room 501 being displayed on the HMD G1.

In the state where the processor 2 has detected that the avatar A3 is facing the avatar A1 as illustrated in FIG. 8A based on the management information (participation status information and gaze direction information about the avatar A2 and the avatar A3) received in step S406, in the HMD G1, the avatar A3 is facing the self-avatar A1 as illustrated in FIG. 8B. In this state, when determining that the avatar A3 is speaking, such that “could you please let us hear your opinion?”, the processor 2 detects that the conversation to the self-avatar A1 has been found in step S701.

Step S702: Based on the participation status information as determined in step S407, the processor 2 proceeds to step S703 when the participation status information is indicative of the “temporary absence mode 1”, proceeds to step S705 when the participation status information is indicative of the “temporary absence mode 2”, and proceeds to step S711 when the participation status information is indicative of the “temporary absence mode 3”.

Step S703: In the process of the “temporary absence mode 1”, based on the participation status information and the gaze direction information about the other users received in step S406, as illustrated in FIG. 6B, the processor 2 cancels the through mode and carries out the display control for the images of the virtual conference room and output control for the audio information in the same manner as the process of step S408.

Step S704: The video information about the virtual conference room 501 is displayed in step S703, and accordingly, the processor 2 sets the “normal mode” in the participation status information and terminates the temporary absence process.

This enables, in the “temporary absence mode 1” in which the user P1 is working on a task, which is different from participation in the conference, on a different personal computer using a keyboard and a mouse, the first user P1 to return to the conference in response to a conversation by other users in the conference in the virtual conference room 501.

In step S705, in the process of the “temporary absence mode 2”, the processor 2 determines whether pairing with a mobile information terminal S1 by near-field wireless communication has been connected. If it is not connected (S705: disconnected), the processor 2 proceeds to step S706. If it is connected (S705: connected), the processor 2 proceeds to step S707.

Step S706: If the distance between the HMD G1 and the mobile information terminal S1 is more than the distance in which near-field wireless communication is available so that pairing by near-field wireless communication is not connected, the processor 2 carries out the processing for connecting with the mobile information terminal S1 through the mobile wireless communication network having a longer communicable distance. Then, the processor 2 proceeds to step S707.

Step S707: The processor 2 sends a message to the first user P1 via the mobile information terminal S1 to ask if he or she wants connection in a remote control mode. The remote control mode is the mode allowing the mobile information terminal S1 to participate in the conference in the virtual conference room via the HMD G1.

If the connection in the remote control mode is not needed (step S707: No), the processor 2 proceeds to step S708. If the connection in the remote control mode is needed (step S707: Yes), the processor 2 proceeds to step S709.

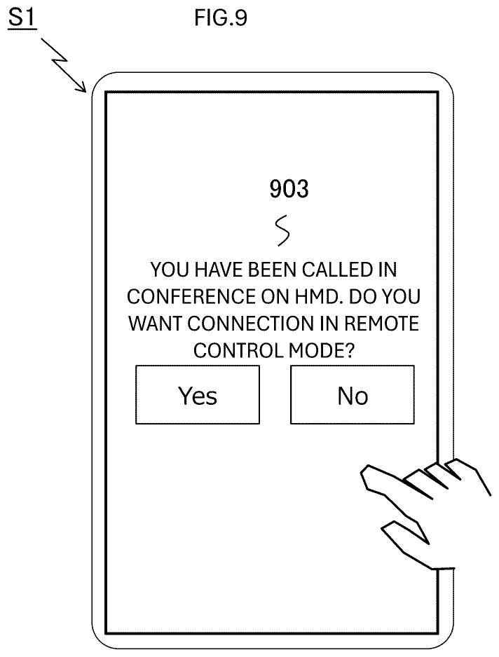

FIG. 9 schematically illustrates a display image to be displayed on the mobile information terminal S1, in which a message for asking if connection in the remote control mode is necessary is being displayed in response to an inquiry from the HMD G1.

On the screen illustrated in FIG. 9, a “Yes” button for requiring the remote connection and a “No” button for not requiring the remote connection are being shown. If the first user P1 taps the “Yes” button, the result of selection is transmitted to the HMD G1, and then the processor 2 proceeds to step S709. If the user P1 taps the “No” button, the result of selection is transmitted to the HMD G1, and then the processor 2 proceeds to step 708.

Step S708: The processor 2 transmits a notification instruction to the mobile information terminal S1.

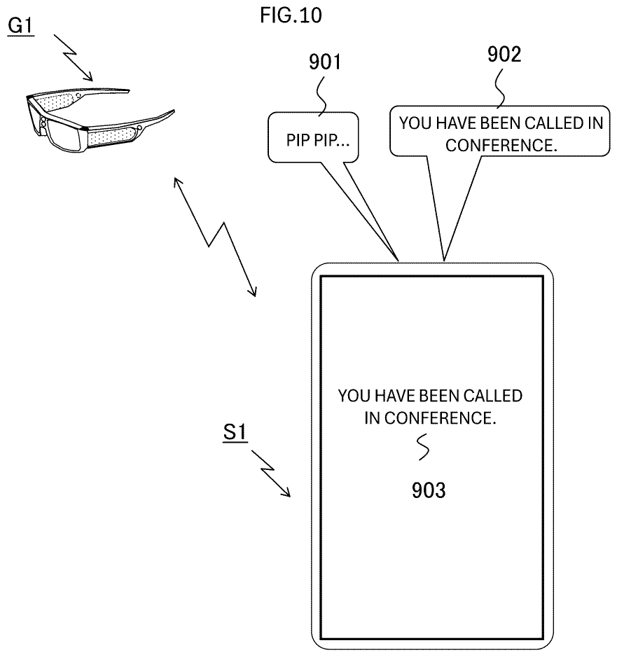

FIG. 10 schematically illustrates operations of the mobile information terminal S1 upon receiving the notification instruction.

Upon receiving the notification instruction, the mobile information terminal S1 outputs a notification sound 901 and a message voice 902 from the right speaker 85R and the left speaker 85L. In addition, the mobile information terminal S1 may display a message 903. How the notification sound 901, the message voice 902, and the message 903 are to be combined is not particularly limited.

This enables the user P1 who is temporarily absent to check the notification using the mobile information terminal S1, return to the location where the HMD G1 is placed, and participate in the remote conference again.

Step S709: When the first user P1 taps the “Yes” button on the screen illustrated in FIG. 9, a remote-connection-request instruction signal is transmitted from the mobile information terminal S1 to the HMD G1. In response to the remote-connection-request instruction signal, the processor 2 of the HMD G1 transmits and controls the images and audio of the virtual conference room 501 to the mobile information terminal S1.

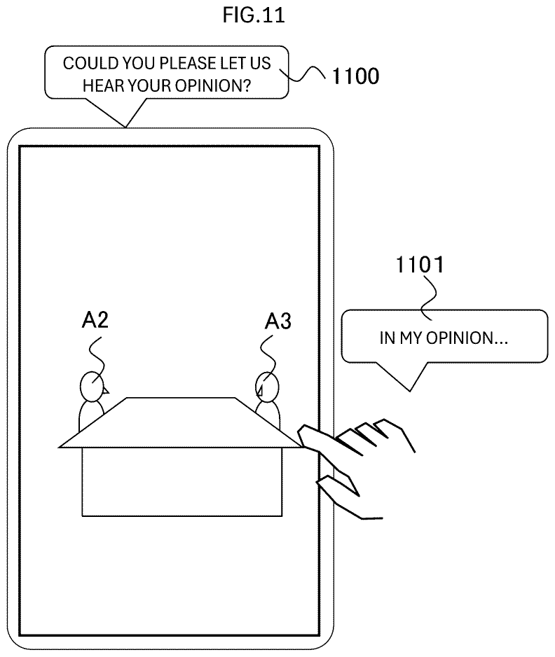

FIG. 11 schematically illustrates operations in the remote control mode.

As illustrated in FIG. 11, the mobile information terminal S1 displays the images of the virtual conference room 501 that have been transferred and controlled from the HMD G1, and outputs an audio 1100.

Upon returning a reply 1101 to the audio 1100, if the first user P1 taps the avatar A3 by a remote control operation, the information about the tap position is transmitted as a remote control command to the HMD G1, and the audio of the reply 1101 is transmitted to the HMD G1.

Step S710: The HMD G1 receives the audio of the reply and the remote control command from the mobile information terminal S1.

The remote control command is, for example, the command for changing the direction of the face of the self-avatar A1. When the first user P1 taps the avatar A3 being displayed on the mobile information terminal S1, the gaze direction information for causing the avatar A1 to face the direction of the avatar A3 is generated based on the information about the tap position. This gaze direction information corresponds to one type of the remote control command.

The HMD G1 transmits the gaze direction information and the audio information about the reply 1101, which have been received from the mobile information terminal S1, to the management server 15.

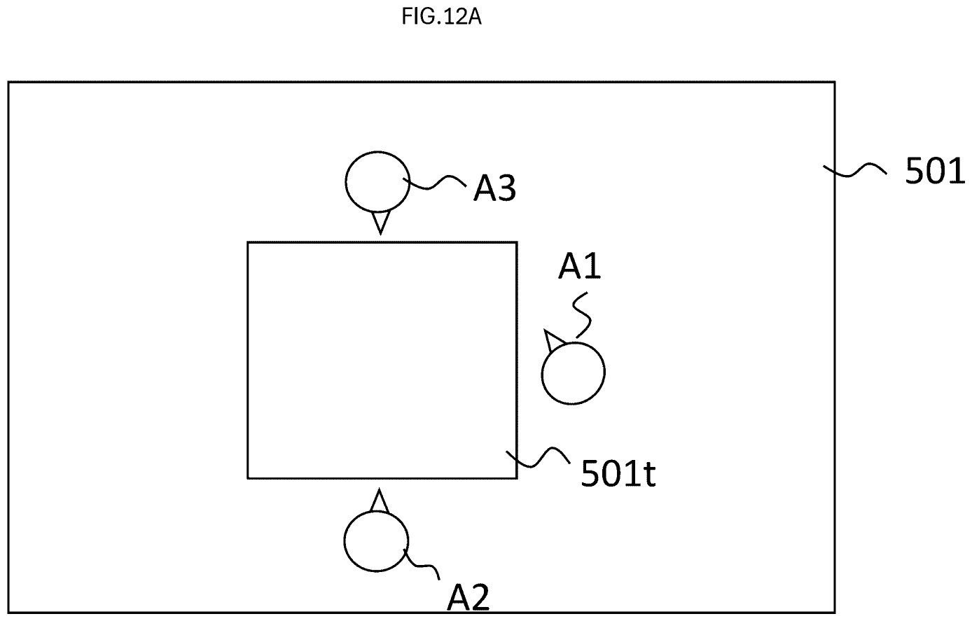

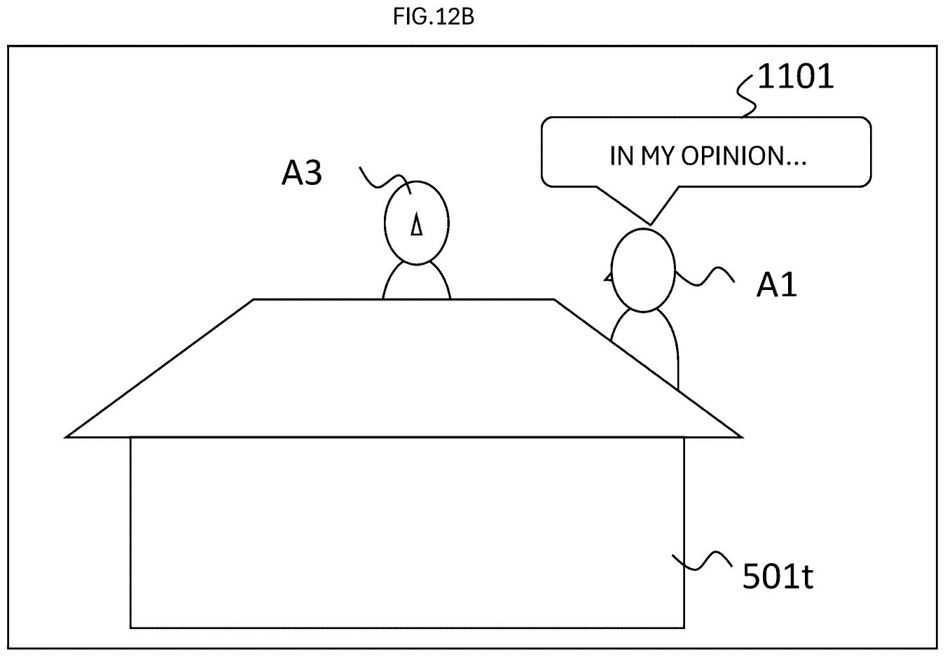

FIG. 12A schematically illustrates the virtual conference room 501 from above. FIG. 12B schematically illustrates a display image of the virtual conference room 501 being displayed on the HMD G2.

The HMD G2 receives the gaze direction information and the audio information about the HMD G1 via the management server 15. The processor 2 of the HMD G2 carries out an internal process for display control based on the gaze direction information and the audio information about the HMD G1 as received. This process causes, as illustrated in FIG. 12A with an overhead view, the avatar A1 to face the direction of the avatar A3, and as illustrated in FIG. 12B with a viewpoint of the avatar A3, a video in which the avatar A1 is facing the avatar A3 to be displayed on the right display 202R and the left display 202L of the HMD G2. In addition, on the HMD G2, the video in which the avatar A1 is giving the reply 1101 that has been made by the first user P1, by means of his or her voices is displayed.

Although not illustrated, on the HMD G3 of the third user P3, a video in which the avatar A1 is facing the direction of the third user P3 himself or herself in the virtual conference room 501 is displayed.

Thus, the first user P1 who is temporarily absent can participate in the conference again and send the audio information even without returning to the location where the HMD G1 is being placed. Furthermore, performing a remote control operation (FIG. 11) allows the direction in which the self-avatar A1 is facing to be controlled even if the user P1 is not wearing the HMD G1.

Step S711: In the process of the “temporary absence mode 3”, the processor 2 outputs the audio information from the right speaker 85R and the left speaker 85L to notify it to the first user P1.

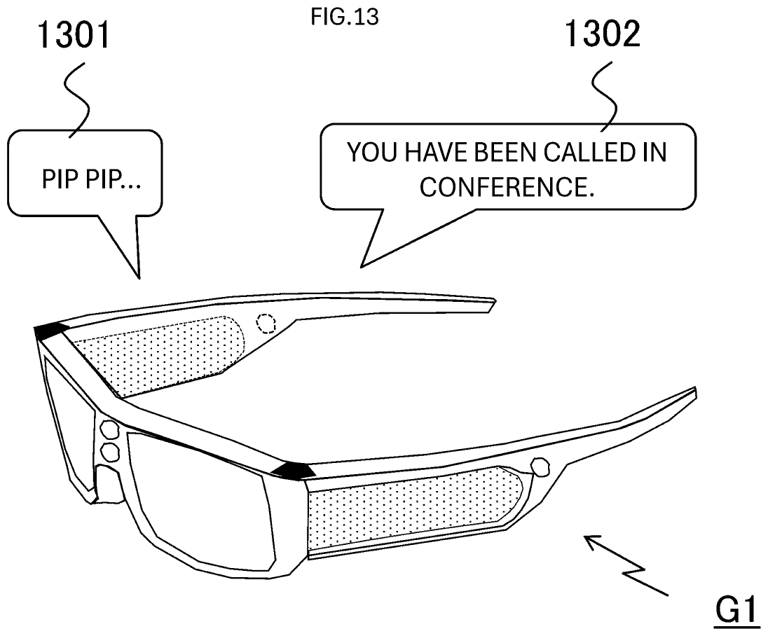

FIG. 13 schematically illustrates the state in which the HMD G1 is performing an audio notification operation.

The HMD G1 outputs a notification sound 1301 and a message voice 1302 from the right speaker 85R and the left speaker 85L to notify them to the first user P1. How the notification sound 1301 and the message voice 1302 are to be combined is not particularly limited.

According to the first embodiment, even if a user is taken off the HMD G1 and temporarily absent from the virtual conference room 501, providing the user with a notification through the mobile information terminal S1 enables him or her to be notified that he or she needs to return to the conference.

Furthermore, connecting the mobile information terminal S1 to the HMD allows the user to participate in the conference in the virtual conference room on the mobile information terminal S1. At this time, by sending not only the audio information but also the gaze direction information to designate the direction to which the face of the self-avatar is to be turned, the direction of the face of the self-avatar can be changed even if the user is not wearing the HMD. This enables the gaze direction of the self-avatar to be changed in the video being displayed for the other users who are participating in the virtual conference room, which can eliminate the unnaturalness of the direction of the face of the self-avatar caused by the temporary absence.

Still further, in the embodiment described above, the connection system between the HMD and the mobile information terminal is switched depending on the temporary absence condition, and accordingly, even if the user moves away from the HMD and thus exceeds the range in which pairing by the near-field wireless communication can be obtained, he or she can participate in the virtual conference room again.

As described above, according to the present embodiment, it is possible to prevent the delay in the progression of the conference and unnatural motions in the video during the virtual conference, which may be caused by temporary absence of a user. As virtual conferences become more popular and more frequent and they go for longer, possibilities that users take off the HMDs during the conferences may increase. However, according to the present embodiment, it is possible to realize a user-friendly virtual conference system capable of preventing the conversations in the virtual conferences from being delayed even in such circumstances.

### Second Embodiment

The second embodiment is an embodiment including, in addition to the features according to the first embodiment, a configuration for notifying temporary absence of a participant to the other participants.

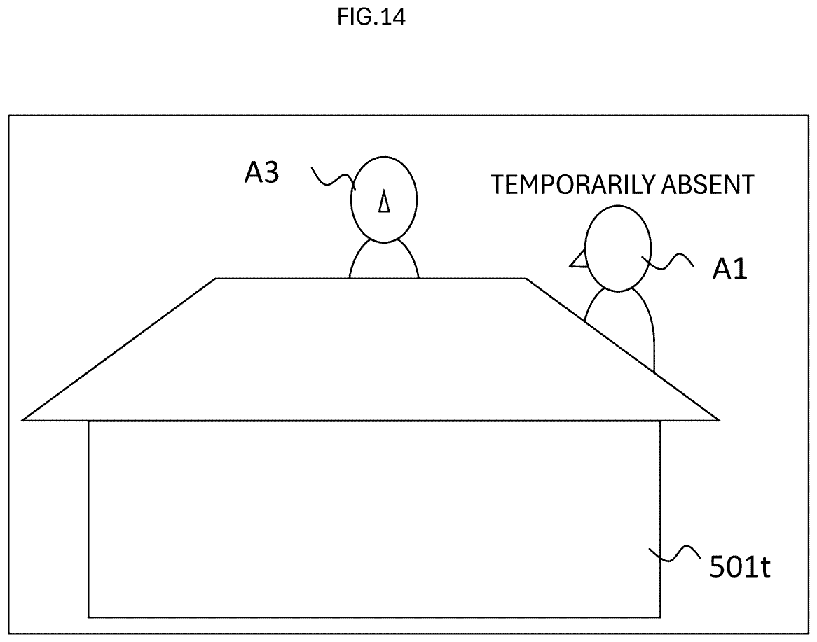

FIG. 14 schematically illustrates a display image of the virtual conference room 501 being displayed on the HMD G2.

FIG. 14 illustrates a display image as viewed from the avatar A2 in the virtual conference room, which is a first-person view image being displayed on the HMD G2 of the second user P2 while the first user P1 is temporarily absent from the remote conference.

In FIG. 14, the processor 2 of the HMD G2 carries out control of displaying the text, “temporarily absent”, near the avatar A1 of the first user P1 who is temporarily absent from the conference. Although not illustrated, the same applies to the HMD G3 of the third user P3.

This enables all the other users P2 and P3, who are participating in the conference, to know that the first user P1 is temporarily absent but is ready to respond to the conversation at any time.

The text to be displayed during temporary absence may not be limited to “temporarily absent”, but any means may be employed as long as it expresses the situation of the first user P1 in which he or she is able to come back to the conference immediately as needed. For example, a certain figure may be used, or the color and brightness of the self-avatar A1 may be changed.

### Third Embodiment

The third embodiment is an embodiment including, in addition to the features according to the first embodiment, a configuration for notifying that a participant is temporarily absent but participating in a virtual conference in the remote control mode to the other participants.

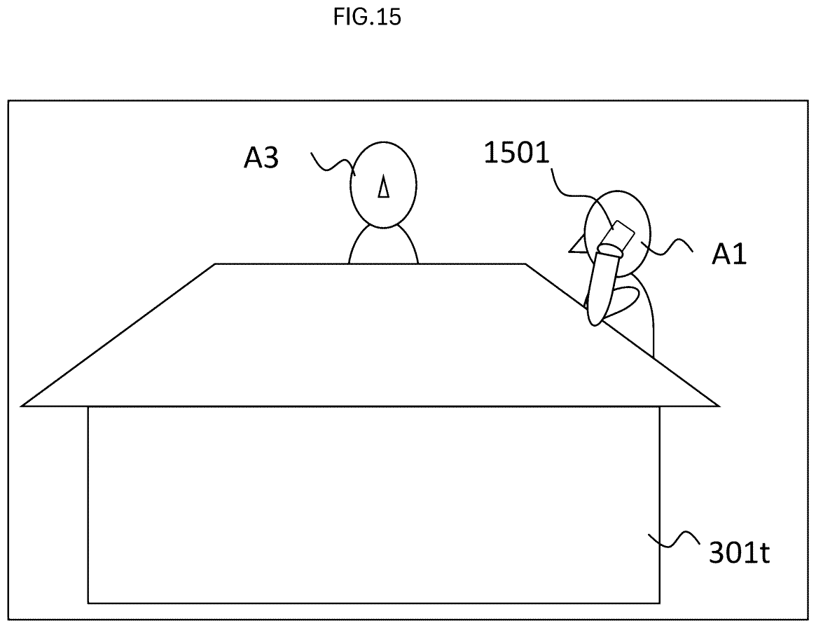

FIG. 15 schematically illustrates a display image of the virtual conference room 501 being displayed on the HMD G2.

FIG. 15 illustrates a display image as viewed from the avatar A2 in the virtual conference room, which is a first-person view image being displayed on the HMD G2 of the second user P2 while the first user P1 is temporarily absent from the remote conference.

Upon participation of the HMD G1 in the remote control mode, as illustrated in FIG. 15, the processor 2 of the HMD G2 displays an image in which the avatar A1 is holding a smartphone 1501 in its hand.

This enables the other users to know that the first user P1 is temporarily absent but is participating in the conference in the remote control mode.

The means for notifying the participation in the remote control mode is not limited to displaying the image in which the avatar is holding a smartphone in its hand, but any means may be employed as long as it can let the other users to know that the participant is participating in the conference in the remote control mode nearby.

### Fourth Embodiment

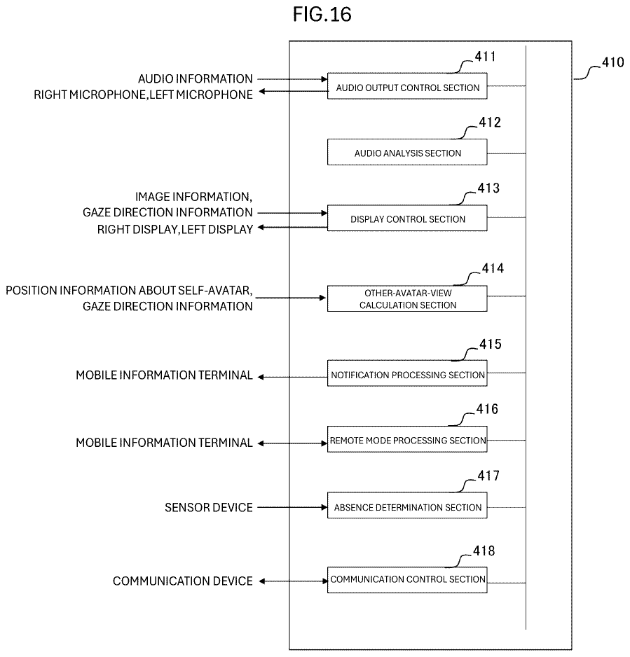

The fourth embodiment relates to an example of a process for detecting a conversation to a self-avatar (step S701). FIG. 16 is a functional block diagram of a video display program to be executed by the processor 2.

A video display program 410 illustrated in FIG. 16 is stored in the program storage area 41 of the memory 4 of the HMD G1 and loaded and executed in the work area 43, whereby the functions thereof are implemented. The video display programs 410 are also installed in the HMD G2 and the HMD G3 worn by the other users who attend the virtual conference, respectively, for implementing the same functions as those to be described later therein.

The video display program 410 includes an audio output control section 411, an audio analysis section 412, a display control section 413, an other-avatar-view calculation section 414, a notification processing section 415, a remote mode processing section 416, an absence determination section 417, and a communication control section 418.

The audio output control section 411 is configured to cause the right speaker 85R and the left speaker 85L of the HMD G1 to output the audio information about the voices uttered by the other users as received from the distribution server 14.

The audio analysis section 412 is configured to detect, using an artificial intelligence engine for analyzing natural languages, a proper noun corresponding to the name of a user, and a general expression for speaking to another person without including a term allowing a specific person to be recognized, such as “what do you think about ...?”, “hey”, or the like, which are included in the audio information.

The display control section 413 is configured to generate a video of another avatar based on the video information, the gaze direction information, and the behavior information received from the distribution server 14, and display the video on the right display 202R and the left display 202L.

The other-avatar-view calculation section 414 is configured to determine whether the self-avatar is included in the line-of-sight direction of another avatar based on the video information and the gaze direction information received from the distribution server 14. Specifically, the other-avatar-view calculation section 414 calculates, as a field of view of another avatar, a horizontal direction angle range and a vertical direction angle range, which are predetermined around a vector indicative of a gaze direction starting from a position of another avatar within the virtual space. The other-avatar-view calculation section 414 determines that the other avatar is facing the direction of the self-avatar when the self-avatar is included in the field of view as calculated.

The notification processing section 415 is configured to provide the mobile information terminal S1 connected to the HMD G1 with a notification that the self-avatar has been talked to, upon detection of a conversation to the self-avatar.

The remote mode processing section 416 is configured to execute a process relating to the remote mode for the HMD G1 and the mobile information terminal S1, upon selection of the remote mode.

The absence determination section 417 is configured to determine whether the first user P1 has attached or detached the HMD G1. The absence determination section 417 determines that the first user is temporarily absent upon determining that the first user P1 has detached the HMD G1 while participating in the conference. The absence determination section 417 may be configured to determine only whether he or she is participating in the conference or temporarily absent, or, as described for the first embodiment, determine to which the plurality of temporary absence modes the status of the first user P1 corresponds.

The communication control section 418 is configured to execute communication control among the HMD G1, the distribution server 14, the management server 15, and the mobile information terminal S1.

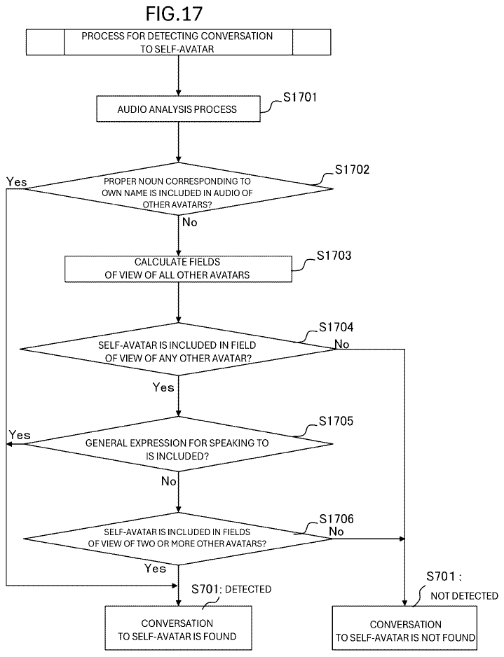

FIG. 17 illustrates a flowchart of a flow of the process for detecting a conversation to a self-avatar.

The audio analysis section 412 analyzes whether the audio information about another user received from the distribution server 14 includes a proper noun corresponding to his or her own name or a general expression for speaking thereto (S1701). If the proper noun corresponding to his or her own name (S1702: Yes), the audio analysis section 412 determines that the self-avatar has been talked to (S701: Yes).

If no proper noun corresponding to his or her own name is found (S1702: No), the other-avatar-view calculation section 414 calculates the field of views of all the other avatars (S1703).

The other-avatar-view calculation section 414 determines whether the self-avatar is included in the field of view of any other avatar. The position information about the self-avatar may be seat position information about the self-avatar which has been input to the operation input device 9 by means of the operation performed thereon, or it may be received from the distribution server 14. If the determination is indicative of a negative result (1704: No), it is determined that the self-avatar has not been talked to (S701: No).

When the other-avatar-view calculation section 414 determines that the self-avatar is included in the field of view of any other avatar (S1704: Yes) and the audio analysis section 412 determines that the audio information includes a generic expression for speaking to (S1705: Yes), it is determined that the self-avatar has been talked to (S701: Yes).

When the other-avatar-view calculation section 414 determines that the self-avatar is not included in the field of view of any other avatar (S1704: Yes) and the audio analysis section 412 determines that the audio information does not include a general expression for speaking to (S1706: No), the other-avatar-view calculation section 414 determines whether the self-avatar is included in the fields of view of two or more other avatars (S1706). If the determination is indicative a positive result, it is determined that the self-avatar has been talked to (S701:
Yes). If it is indicative of a negative result, it is determined that the self-avatar has not been talked to (S701: No).

According to the present embodiment, it is possible to detect whether the self-avatar has been talked to, using the conditions of whether a proper noun corresponding to the name of a user has been detected, whether a self-avatar of the user is included within the field of view of any other avatar, or how much attention the self-avatar is receiving.

The embodiments described above are not intended to limit the present invention, and the present invention can be realized with other various embodiments.

For example, instead of using an HMD, a laptop computer, a tablet, a smartphone, or a display or a projector connected to a desktop computer by wire or wirelessly may be used as the video display device.

In this case, an in-camera for capturing an image of a real space facing the display of each device may be used as the participation detection sensor, and it may be determined that the user is temporarily absent if the user is not captured in the image by the in-camera. The in-camera may be integrally formed with the video display device, or an external camera may be provided as the in-camera.

The present invention is not limited to the embodiments described above, and various modifications can be made for the present invention. For example, the embodiments described above have been explained in detail for the purpose of making it to understand the present invention easily, and thus are not necessarily limited to those having all the configurations as described.

In the above, the example of system setting when the user enters the virtual conference room or while he or she is in the virtual conference room has been described, however, the present invention is not limited thereto, and the default values of the system or preset values that the user has set in advance may be used.

Furthermore, a part of the configuration of an embodiment may be replaced with the configuration of a further embodiment, and the configuration of an embodiment may include the configuration of a further embodiment. It is also possible to add, delete, or replace a part of the configuration of each embodiment with the configuration of a further embodiment.

Still further, in each of the configurations described above, some or all of them may be implemented by hardware, or by executing a program on the processor. The control lines and information lines which are considered to be necessary for the purpose of explanation are indicated herein, but not all the control lines and information lines of actual products are necessarily indicated. It may be considered that almost all the components are actually connected to each other.

The embodiments described above include the following aspects of the present invention.

### (Appendix 1)

A video display device, comprising:
a processor;
a display;
a participation detection sensor configured to detect whether a user is participating in a conversation in a virtual space received via the video display device; and
a first communication transceiver configured to receive video information about the virtual space in which a self-avatar corresponding to the user is present, video information about another avatar corresponding to another user, and audio information about the other user from an external device,
the processor being configured to:
   based on the video information about the virtual space and the video information about the other avatar, generate a video in which the other avatar is arranged in the virtual space to display the video as generated on the display;
   determine whether the user is in a temporarily absent state in which the user is not participating in the conversation with the self-avatar being arranged in the virtual space, based on a sensor output from the participation detection sensor; and
   upon determining that the other avatar is speaking to the self-avatar based on the audio information while the user is in the temporarily absent state, carry out control for providing the user with a notification.

### (Appendix 2)

A video display system, comprising:
a distribution server; and
a video display device,
the distribution server and the video display device being connected with each other by communication,
the distribution server being configured to:
   distribute video information about a virtual space in which a self-avatar corresponding to a first user is present to the video display device being operated by the first user; and
   distribute, to the video display device, video information about another avatar corresponding to a second user which is present in the virtual space, and audio information about the second user,
the video display device including:
   a processor;
   a display;
   a participation detection sensor configured to detect whether the first user is participating in a conversation in the virtual space; and
a communication transceiver configured to receive the video information about the virtual space, the video information about the other avatar, and the audio information, and
the processor being configured to:
   based on the video information about the virtual space and the video information about the other avatar, generate a video in which the other avatar is arranged in the virtual space to display the video as generated on the display;
   determine whether the first user is in a temporarily absent state in which the first user is not participating in the conversation with the self-avatar being arranged in the virtual space, based on a sensor output from the participation detection sensor; and
   upon determining that the other avatar is speaking to the self-avatar based on the audio information while the first user is in the temporarily absent state, carry out control for providing the first user with a notification.

### (Appendix 3)

A video display device control method, comprising:
receiving, from an external device, video information about another avatar corresponding to another user being arranged in a virtual space in which a self-avatar corresponding to a user is present, and audio information about the other user;
based on video information about the virtual space and the video information about the other avatar, generate a video in which the other avatar is arranged in the virtual space to display the video as generated on a display;
based on a sensor output from a participation detection sensor configured to detect whether the user is participating in a conversation in the virtual space, determining whether the user is in a temporarily absent state in which the user is not participating in the conversation with the self-avatar being arranged in the virtual space; and
upon determining that the other avatar is speaking to the self-avatar based on the audio information while the user is in the temporarily absent state, carry out control for providing the user with a notification.

### REFERENCE SIGNS LIST

2: processor
3: bus
4: memory
5: sensors
6: communication transceiver
7: video processing device
8: audio processing device
9: operation input device
10: line-of-sight detection device
11: control device
13: communication network
14: distribution server
15: management server
41: program storage area
42: data storage area
43: work area
51: GPS sensor
52: geomagnetic sensor
53: attachment and detachment detection sensor
54: acceleration sensor
55: gyroscope sensor
61: LAN communication transceiver
62: mobile wireless communication transceiver
63: near-field wireless communication transceiver
71: camera
81: microphone
82: audio recognition processor
83: decoder
84: encoder
85L: left speaker
85R: right speaker
100: video display system
202L: left display
202R: right display
410: video display program
411: audio output control section
412: audio analysis section
413: display control section
414: other-avatar-view calculation section
415: notification processing section
416: remote mode processing section
417: absence determination section
418: communication control section
501: virtual conference room
501t: conference desk
601: display image
708: step
901: notification sound
902: message voice
903: message
1001L: left line-of-sight detection sensor
1001R: right line-of-sight detection sensor
1100: audio
1101: reply
1301: notification sound
1302: message voice
1501: smartphone
A1: self-avatar
G1: HMD
G1a: HMD
G10: housing
P1: first user
P2: second user
P3: third user
R1: wireless router
R2: wireless router
R3: wireless router
S1: mobile information terminal

1. A video display device, comprising:
a processor;
a display;
a participation detection sensor configured to detect whether a user is participating in a conversation in a virtual space received via the video display device; and
a first communication transceiver configured to receive video information about the virtual space in which a self-avatar corresponding to the user is present, video information about another avatar corresponding to another user, and audio information about the other user from an external device,
the processor being configured to:
based on the video information about the virtual space and the video information about the other avatar, generate a video in which the other avatar is arranged in the virtual space to display the video as generated on the display;
determine whether the user is in a temporarily absent state in which the user is not participating in the conversation with the self-avatar being arranged in the virtual space, based on a sensor output from the participation detection sensor; and
upon determining that the other avatar is speaking to the self-avatar based on the audio information while the user is in the temporarily absent state, carry out control for providing the user with a notification.

2. The video display device according to claim 1, further comprising a camera for capturing a video of an external field in which the user is present, wherein
the processor has, as control modes of the video display device, a through mode for displaying the video of the external field captured by the camera on the display, and a normal mode for displaying the video information on the display, and
the processor is configured to:
determine that the user is in the temporarily absent state while the through mode is being used as a control mode; and
upon determining that the other avatar is speaking to the self-avatar while the user is in the temporarily absent state, cancel the through mode and shift the control mode to the normal mode.

3. The video display device according to claim 1, further comprising a speaker, wherein
the processor has, as control modes of the video display device, a speaker mode for outputting an audio based on the audio information from the speaker, and a normal mode for displaying the video information on the display, and
the processor is configured to determine that the user is in the temporarily absent state while the speaker mode is being used as a control mode.

4. The video display device according to claim 1, further comprising a second communication transceiver for carrying out a wireless communication connection with a mobile information terminal, wherein
the processor is configured to execute control for causing the second communication transceiver to transmit the notification to the mobile information terminal upon determining that the other avatar is speaking to the self-avatar based on the audio information while the user is in the temporarily absent state.

5. The video display device according to claim 4, wherein
the processor is configured to transfer the video information and the audio information to the mobile information terminal, and
execute a remote control mode of receiving an audio of the user and a remote control command for designating a gaze direction of the self-avatar and transferring the remote control command as received to the external device.

6. The video display device according to claim 4, wherein
the video display device is a head-mounted display, and
the participation detection sensor is an attachment and detachment detection sensor for the head-mounted display.

7. The video display device according to claim 1, wherein
the participation detection sensor is an in-camera for capturing an image of a real space facing the display, and
the processor is configured to determine that the user is in the temporarily absent state when the user is not included in the image captured by the in-camera.

8. A video display system, comprising:
a distribution server; and
a video display device,
the distribution server and the video display device being connected with each other by communication,
the distribution server being configured to:
distribute video information about a virtual space in which a self-avatar corresponding to a first user is present to the video display device being operated by the first user; and
distribute, to the video display device, video information about another avatar corresponding to a second user which is present in the virtual space, and audio information about the second user,
the video display device including:
a processor;
a display;
a participation detection sensor configured to detect whether the first user is participating in a conversation in the virtual space; and
a communication transceiver configured to receive the video information about the virtual space, the video information about the other avatar, and the audio information, and
the processor being configured to:
based on the video information about the virtual space and the video information about the other avatar, generate a video in which the other avatar is arranged in the virtual space to display the video as generated on the display;
determine whether the first user is in a temporarily absent state in which the first user is not participating in the conversation with the self-avatar being arranged in the virtual space, based on a sensor output from the participation detection sensor; and
upon determining that the other avatar is speaking to the self-avatar based on the audio information while the first user is in the temporarily absent state, carry out control for providing the first user with a notification.

9. A video display device control method, comprising:
receiving, from an external device, video information about another avatar corresponding to another user being arranged in a virtual space in which a self-avatar corresponding to a user is present, and audio information about the other user;
based on video information about the virtual space and the video information about the other avatar, generate a video in which the other avatar is arranged in the virtual space to display the video as generated on a display;
based on a sensor output from a participation detection sensor configured to detect whether the user is participating in a conversation in the virtual space, determining whether the user is in a temporarily absent state in which the user is not participating in the conversation with the self-avatar being arranged in the virtual space; and
upon determining that the other avatar is speaking to the self-avatar based on the audio information while the user is in the temporarily absent state, carry out control for providing the user with a notification.
